(19) United States
(12) Patent Application Publication
(10) Pub. No.: US 2024/0329868 A1
(43) Pub. Date: Oct. 3, 2024

(54) DATA REWRITING METHOD

(71) Applicant: LAPIS Technology Co., Ltd., Yokohama (JP)

(72) Inventor: Yusuke HATA, Yokohama-shi (JP)

(73) Assignee: LAPIS Technology Co., Ltd., Yokohama (JP)

(21) Appl. No.: 18/619,596

(22) Filed: Mar. 28, 2024

(30) Foreign Application Priority Data
Mar. 29, 2023 (JP) 2023-054164

(51) Int. Cl. G06F 3/06

(52) U.S. Cl. CPC G06F 3/064; G06F 3/0604; G06F 3/0659; G06F 3/0673

(57) ABSTRACT

For a memory space including data words for storing data associated with a block number for identifying plural blocks and a data address for each of the blocks, in a memory configuration provided with a memory group configured including plural data words each respectively stored with data associated with the data address belonging to each of the respective block groups, and including at least one spare data word, in cases in which data of the data address is designated to be updated, a computer writes data after updating of the designated data address to a data word 1C in a memory group containing the data word for storing the data of the designated data address.

### CROSS-REFERENCE TO RELATED APPLICATION

This application is based on and claims priority under 35 USC 119 from Japanese Patent Application No. 2023-054164 filed on Mar. 29, 2023, the disclosures of which are incorporated by reference herein.

### TECHNICAL FIELD

The present disclosure relates to a data rewriting method for memory.

### RELATED ART

Japanese Patent No. 3702923 (Patent Document 1) discloses an information processing method that, by configuring a memory from physical blocks serving as a data area for storing data, and physical blocks serving as a first area and a second area for storing physical block numbers of the physical blocks configuring the data area, maintains the integrity of individual data even when memory corruption has occurred in the middle of writing plural data to plural logical blocks.

An example of a configuration of the memory of Patent Document 1 is illustrated in FIG. 7. The memory of Patent Document 1 is prepared with a first area 20 and a second area 21 including a target pointer area 22 indicating a target block 31 of a data area 30, an update pointer area 23 indicating an update block 32 of the data area 30, validity information 24 indicating validity of data, and latest information 25 indicating a data write-sequence.

The target block 31 is a physical block that should ordinarily be the target for writing when writing data.

The update block 32 is a physical block employed in update and used when updating storage content by writing data to a given physical block.

Four physical block numbers in the target pointer area 22 of the first area 20 and the second area 21 are associated with logical block numbers expressed by % 00 to % 03. For example, the four physical block numbers #00 to #03 in the target pointer area 22 of the first area 20 of FIG. 7 are associated with respective logical block numbers % 00 to % 03. Note that value of “FF” in the memory of FIG. 7 is an initial value of the memory, and expresses a state in which data has not even been written once thereto.

For example consider a case in which there is request to respectively write data to logical blocks expressed by logical block number % 00 and logical block number % 02 while in a state in which only the first area 20 is indicated as being valid by the validity information 24. In such cases, reference to the target pointer area 22 of the first area 20 reveals that the physical block numbers #00 and #02 correspond to the logical block number % 00 and logical block number % 02, respectively. Thus the physical blocks expressed by #00 and #02 are ascertained to be the target blocks 31 for data writing.

Furthermore, the physical block numbers of the update block 32 #04 and #05 are obtained by referencing the update pointer area 23 of the first area 20 for the number of physical blocks for data writing in sequence from the left.

This means that in the memory of Patent Document 1, the data that would ordinarily be written to the physical blocks in the target block 31 indicated by the physical block numbers #00 and #02 is written to the physical blocks in the update block 32 having the respective physical block numbers of #04 and #05.

FIG. 8 is a diagram illustrating an example in which data has been written to physical blocks in the update block 32.

Then the target pointer arca 22 of the first area 20 is copied to the target pointer area 22 of the second area 21, the physical block numbers of the physical blocks in the update block 32 to which data has been written, which are #04 and #05, are then respectively written to the areas of the target pointer area 22 in the second area 21 that are associated with logical block numbers % 00 and % 02.

Moreover, the update pointer area 23 of the first area 20 is copied to the update pointer area 23 of the second area 21, the physical block numbers of the physical blocks that would ordinarily be the destinations for writing data to, which are #00 and #02, are written to the update pointer area 23 of the second area 21, the validity information 24 of the second area 21 is set to valid and also the validity information 24 of the first area 20 is set to invalid.

Namely, writing of data to the designated logical block numbers is not performed to the target block 31 and is instead performed to the update block 32, and so data stored in the target block 31 remains as is. This means that even in cases in which writing of data to the memory was unable to be performed normally due to a communication failure or the like, for example, then the original data can be restored by determining the block where the original data was stored prior to data writing by referencing the validity information 24 stored in the first arca 20 and the second area 21.

However, in such a configuration, the first area 20 and the second area 21 are rewritten to alternately every time data writing occurs. More specifically, four pointers indicating respective physical blocks in the target pointer area 22 and the update pointer area 23 of the first area 20 and the second area 21 are stored, and rewriting of the target pointer area 22 and the update pointer area 23 is performed at every request to write to a physical block indicated by a pointer. This means that a total number of times data rewriting occurs in the first area 20 and the second area 21 is twice the number of times of rewriting in each of the physical blocks of the data area 30.

Specifically, in cases in which data write requests are made 100 times each for each of the two blocks, the logical block number % 00 and the logical block number % 01, then this results in respective number of times of rewriting as set out below for the first area 20, the second area 21, and the data area 30. The data of the logical block number % 00 is rewritten alternately in the physical block numbers #00 and #04, and data of the logical block number % 01 is rewritten alternately in the physical block number #01 and #05.

### Number of Times Rewriting

Number of times rewriting first area 20: 100 times×2 blocks/2 areas=100 times
Number of times rewriting second area 21: 100 times×2 blocks/2 areas=100 times
Number of times rewriting physical block numbers #00 and #04 of data area 30: 100 times/2 areas=50 times
Number of times rewriting physical block numbers #01 and #05 of data area 30: 100 times/2 areas=50 times

However, limits are placed on the maximum number of times of rewriting in order to assure operation quality for non-volatile memory such as flash read only memory (Flash ROM) and electrically erasable programmable read only memory (EEPROM). In cases in which a maximum number of times of data rewriting is pre-set, such as in an IC card or the like, this maximum number of times of rewriting is applied not only to the number of times of rewriting of the data area 30, but also to the number of times of rewriting of the pointer areas indicating the data area 30, such as the first area 20 and the second area 21.

This leads to an issue with a data rewriting method compatible to data backup employed hitherto in that the time to reach the maximum number of times of rewriting of a memory is brought forward.

In consideration of the above circumstances, an object of the present disclosure is to provide a data rewriting method capable of performing data backup in a memory, while reducing the number of times of rewriting of data compared to hitherto.

### SUMMARY

A data rewriting method according to the present disclosure is processing executed by a computer. The processing includes: for a memory space including data words for storing data associated with a block number for identifying plural blocks and a data address respectively represented by an address set uniquely for each of the blocks; in a memory configuration provided with a memory group configured including, in cases in which the plural blocks have been split into two or more block groups, plural data words each respectively stored with data associated with the data address belonging to each of the respective block groups, and including at least one spare data word; and, in cases in which data of the data address is designated to be updated, from out of the memory group containing data words for storing data of the designated data address, writing data after updating of the designated data address to a data word stored with data prior to updating the data address to be updated, and to a data word other than a data word stored with latest data of the data address belonging to the block group different to a data word for storing data of the data address to be updated.

### BRIEF DESCRIPTION OF DRAWINGS

FIG. 1 is a diagram illustrating an example of a configuration of a computer.

FIG. 2 is a diagram illustrating an example of a configuration of word data.

FIG. 3 is a diagram illustrating an example of a configuration of a memory group.

FIG. 4 is a diagram illustrating an example of associations between a data address map expressed by a data address, and a data address map expressed by a memory address.

FIG. 5 is a flowchart illustrating an example of a flow of data rewriting processing.

FIG. 6 is a diagram illustrating an example of updating data by data rewriting processing.

FIG. 7 is a diagram illustrating an example of a configuration of a memory hitherto.

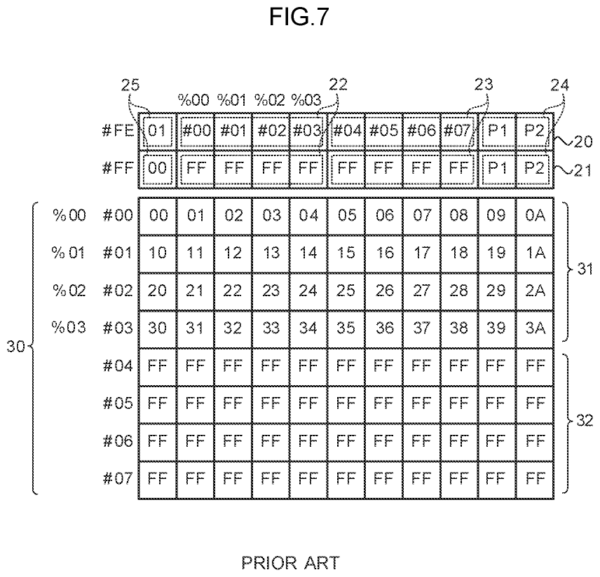

FIG. 8 is a diagram illustrating an example in which data has been rewritten to a physical block.

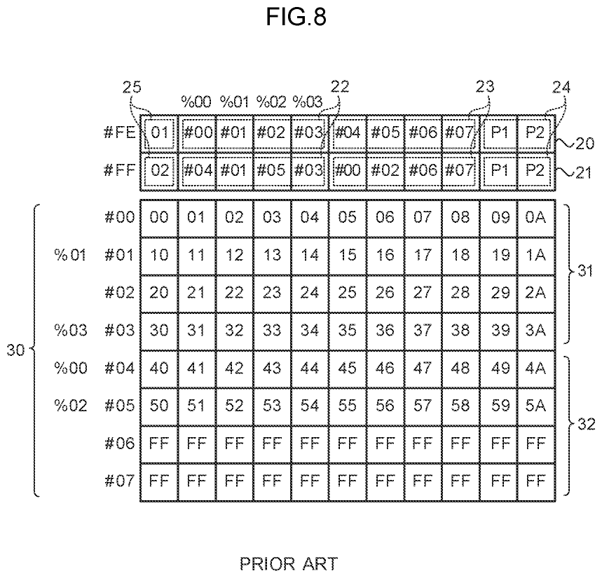

### DETAILED DESCRIPTION

The present disclosure exhibits the excellent advantageous effect of being able to perform data backup in a memory while reducing the number of times of rewriting of data compared to hitherto.

Explanation follows regarding a present exemplary embodiment, with reference to the drawings. Note that the same reference numerals will be appended across the drawings to the same configuration elements and the same processing, and duplicate explanation thereof will be omitted.

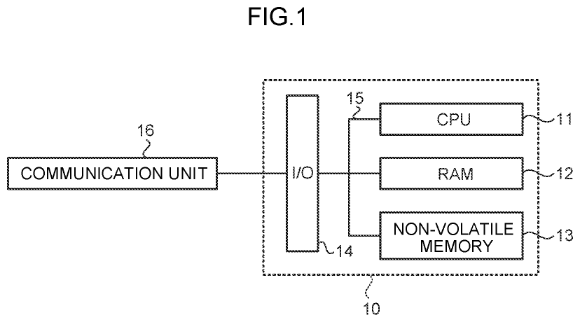

FIG. 1 is a diagram illustrating an example of a configuration of a computer 10 according to the present exemplary embodiment. The computer 10 includes a central processing unit (CPU) 11 serving as an example of a processor, random access memory (RAM) 12 employed as a temporary workspace for the CPU 11, non-volatile memory 13, and an input/output interface (I/F) 14. The CPU 11, the RAM 12, the non-volatile memory 13, and the I/O 14 are connected together through a bus 15.

The non-volatile memory 13 is an example of a storage device that keeps stored information even when power supply to the non-volatile memory 13 is interrupted and, for example, a semiconductor memory may be employed therefore, however a hard disk may also be employed therefore. A program that causes predetermined processing to be executed by the computer 10 is, for example, stored in the non-volatile memory 13.

The non-volatile memory 13 is not necessarily always inbuilt into the computer 10 and, for example, may be a portable storage device, such as a memory card, that is attachable to and detachable from the computer 10. Note that although the non-volatile memory 13 is configured controlled from the CPU 11, the non-volatile memory 13 may be configured so as to be controlled through a controller block.

Units corresponding to functions of the computer 10 are connected to the I/O 14. In the example illustrated in FIG. 1, a communication unit 16 for performing communication with external devices (omitted in the drawings) is connected through a communication line, however obviously the unit(s) connected to the I/O 14 are not limited to the communication unit 16.

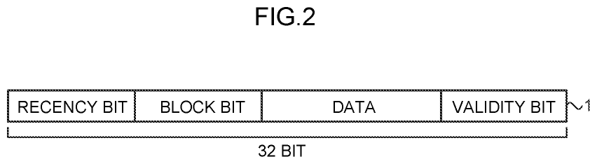

Next, description follows regarding a memory configuration in the non-volatile memory 13. As illustrated in FIG. 2, the non-volatile memory 13 is memory in which there is one word for each address, namely memory is allocated at a 32 bit width. A unit of memory allocated to each address in this manner is called a data word 1. Addresses are associated with each of the data words 1 of the non-volatile memory 13 to identify each of the data words 1. The addresses associated with the data words 1 of the non-volatile memory 13 are called memory addresses.

On the other hand, data handled by the CPU 11 is managed in block units, with one block being configured by 16 words, namely by 16 data words 1.

A block number is appended to the blocks to identify each of the blocks, and also addresses are set for the data words 1 contained in each of the blocks such that the data words 1 in a block are each uniquely identified. Namely, the CPU 11 is able to identify data stored in a designated data word 1 using a combination of the block number with an in-block address.

Addresses of data in a system as expressed by combinations of block numbers with in-block addresses in this manner are called data addresses.

The data words 1 expressed by data addresses, and word addresses in memory space as expressed by memory addresses, are respectively associated with each other as described later, and are reciprocally referable.

Each of the data words 1 contains a recency bit, a block bit, data, and a validity bit.

The recency bit is an example of a sequence area representing an update sequence of data expressed by the data address. For example, consider a case in which two bits are allotted to the recency bit. In cases in which the recency bit is b00 to b10, this means that data is stored in the data word 1, whereas in cases in which the recency bit is b11, this means that data is not stored in the data word 1. The label “b” is a label indicating that a following numerical value is being expressed as binary data.

In cases in which data is stored in the data word 1, a larger value of the recency bit indicates newer data is being stored. Specifically, a data word 1 having a recency bit of b01 indicates that newer data is being stored therein than a data word 1 having a recency bit of b00, and a data word 1 having a recency bit of b10 indicates that newer data is being stored therein than a data word 1 having a recency bit of b01. The recency bit is returned to b00 in cases in which new data is stored after the recency bit has already reached b10. Namely, in a case in which there is a data word 1 expressed with a recency bit of b10 and a data word 1 expressed with a recency bit of b00, the data stored in the data word 1 having the recency bit of b00 is newer data.

The block bit represents a block group to which a data address associated with the stored data belongs. The block group indicates a respective group for cases in which each block is split into two or more groups.

Bit(s) required to uniquely identify a block group are allocated in the block bit. For example, in cases in which a block group is split into two, block A and block B, then the block group is identified by allocating 1 bit as the block bit.

“Data” in the data word 1 represents the data stored in the data word 1.

The validity bit indicates whether or not the data stored in the data word 1 is normal. For example, an error correction code (ECC) or the like is used to determine the validity of data written to the data word 1 when the CPU 11 is writing data to the data word 1, and whether or not the written data is normal is reflected in the validity bit.

For such data words 1, the CPU 11 treats, for example, data words 1 having three consecutive memory addresses as a single memory group 3.

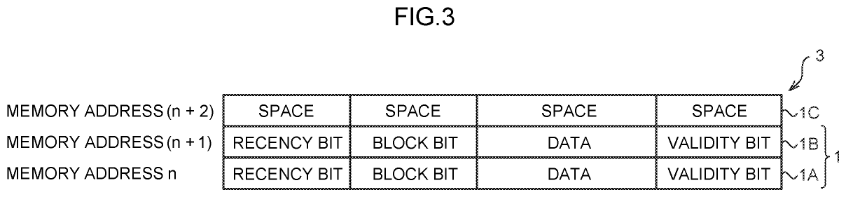

FIG. 3 is a diagram illustrating an example of a configuration of a memory group 3. Description follows regarding an example thereof in which the block group is split into two, block A and block B.

The memory group 3 is configured by a data word 1A storing data associated with a data address of a block belonging to group A, by a data word 1B storing data associated with a data address of a block belonging to group B, and by a spare data word 1C for use in data rewriting.

Namely, the memory group 3 includes the data word 1A and the data word 1B that are cach stored with an item of data associated with a data address belonging to respective block groups resulting from splitting a group, and also includes the spare data word 1C.

Note that in the following the data word 1A, the data word 1B, and the data word 1C are collectively referred to by the expression “the data words 1”.

No information is contained in the data word 1C when in an initial state. The state not containing any information is referred so as being “empty”.

Taking a memory address of the data word 1A as “n”, then memory addresses of the data word 1B and the data word 1C are a memory address (n+1) and a memory address (n+2), respectively. Note that the order of the data word 1A, the data word 1B, then the data word 1C in the memory group 3 is merely an example thereof and, for example the data word 1C may be arranged at the memory address n, the data word 1A may be arranged at the memory address (n+1), and the data word 1B may be arranged at the memory address (n+2).

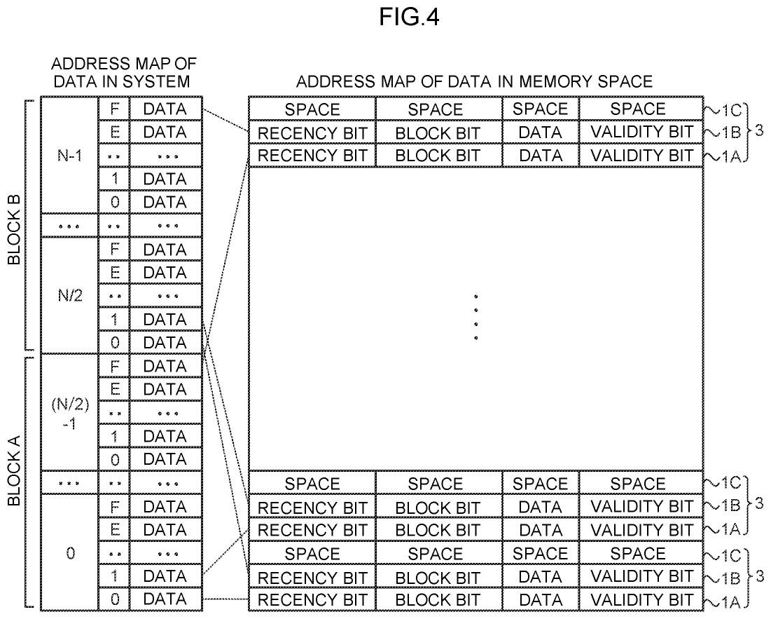

FIG. 4 is a diagram illustrating an example of associations between a data address map expressed by data addresses, and a data address map in memory space expressed by memory addresses. The data word 1A contained in each of the memory groups 3 is stored with data contained in block A, the data word 1B contained in each of the memory groups 3 is stored with data contained in block B.

Next, detailed description follows regarding a method for rewriting data of the data words 1 using a memory structure such as illustrated in FIG. 4.

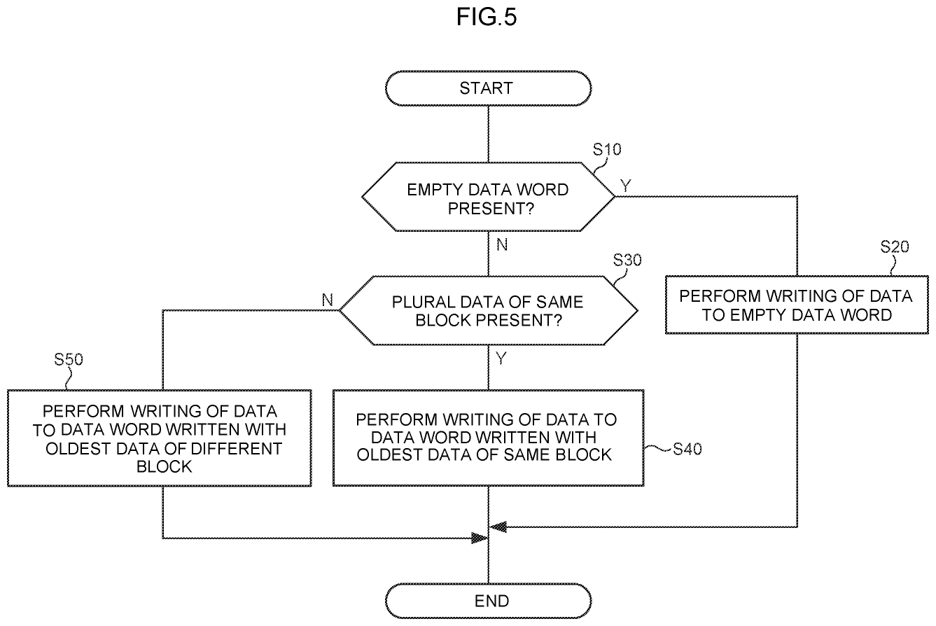

FIG. 5 is a flowchart illustrating an example of a flow of data rewriting processing executed by the CPU 11 for a case in which a request has been received to write data to the data words 1 of a designated data address of a designated block group. The CPU 11 executes data rewriting processing by reading a program from the non-volatile memory 13.

Note that the CPU 11 executes the data rewriting processing illustrated in FIG. 5 on the memory group 3 associated with the data address of the block group where data writing is to be performed.

At step S10, the CPU 11 determines whether or not there is a data word 1C in an initial state in the memory group 3, namely, whether or not there is an empty data word 1C present. Processing transitions to step S20 when there is an empty data word 1C present.

At step S20, the CPU 11 writes data to the empty data word 1C. In such cases, the CPU 11 writes the designated block group to the block bit of the data word 1C, and sets the recency bit of the data word 1C so as to indicate that the latest data in the designated data address of the designated block group is stored in the data word 1C. Moreover, the CPU 11 sets the validity bit of the data word 1C to a value corresponding to the validity of the data written to the data word 1C. This completes the data rewriting processing illustrated in FIG. 5.

On the other hand, processing transitions to step S30 in cases in which determination of the determination processing of step S10 is that there is no empty data word 1C present in the memory group 3.

At step S30, the CPU 11 determines whether or not there are plural data of the same block group to the designated block group present in the memory group 3.

Processing transitions to step S40 in cases in which there are plural data of the same block group of the designated block group present in the memory group 3.

In such cases data having a data address belonging to one or other block group is already written to the data word 1C. Thus at step S40, the CPU 11 performs data rewriting by writing data to the data word 1 that is written with the oldest data from out of the plural data words 1 in the memory group 3 that are written with data of the same block group as the designated block group.

Determining whether or not data of a data address belonging to any block group is written to the data words 1 may be performed with reference to the block bit of the data words 1. Moreover, an update sequence of data at the designated data address of the designated block group may be determined with reference to the recency bit of the data words 1.

Furthermore, the CPU 11 sets a value corresponding to validity of the data written to the data words 1 as the validity bit of the data words 1 written with the data, and also sets the recency bit of the data words 1 written with the data to let it be known that the latest data is stored in the designated data address of the designated block group. The data rewriting processing indicated in FIG. 5 is finished thereby.

On the other hand, processing transitions to step S50 in cases in which determination of the determination processing of step S30 is that there are not plural data of the same block group as the designated block group present in the memory group 3.

Such cases result in plural data having data addresses belonging to a different block group than the designated block group to write the data word 1 to configuring the memory group 3. Thus at step S50, the CPU 11 performs data rewriting to write data to the data word 1 written with the oldest data from out of the plural data words 1 in the memory group 3 written with data of a block group different to the designated block group.

Whether data is written at a data address belonging to any block group of data words 1 may be determined with reference to the block bit of the data words 1. Moreover, the update sequence for data having a data address belonging to a block group different to the designated block group may be determined with reference to the recency bit of the data words 1.

Furthermore, the CPU 11 sets a value corresponding to validity of the data written to the data words 1 in the validity bit of the data words 1 written with the data, and also sets the recency bit of the data words 1 written with data to let it be known that the latest data is stored in the designated data address of the designated block group. Moreover, the CPU 11 updates the block bit of the data word 1 written with the data to let it be known that the written data is data of the designated block group. The data rewriting processing indicated in FIG. 5 is finished thereby.

Namely, when updating the data of the designated data address, from out of the memory group 3 including the data words 1 for storing the data of the designated data address, the CPU 11 executes processing to write data after updating of the designated data address to the data word 1 stored with the data prior to updating the data address to be updated, and to a data word 1 other than the data word 1 stored with the latest data of the data address belonging to a block group different from the data word 1 for storing the data of the data address to be updated.

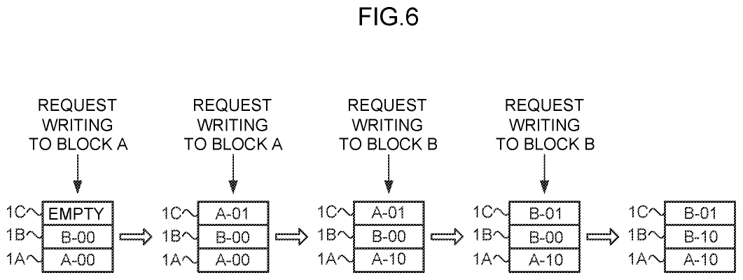

FIG. 6 is a diagram illustrating an example of updating data of the designated data address according to the data rewriting processing indicated in FIG. 5.

A symbol resulting from combining a number with alphabet in the data word 1 of the memory group 3 of FIG. 6 is expressed by a combination of [block bit]-[recency bit] in the corresponding data word 1, and for ease of explanation is referred to as “storage status”. In cases in which, for example, the notation of the storage status is “A-00”, then this indicates that the block bit indicates block A, and that the recency bit indicates b00.

The data word 1A that has a storage status of “A-00”, the data word 1B that has a storage status of “B-00”, and an empty data word 1C are contained in the memory group 3 associated with the data address to be updated.

In this embodiment, in cases in which there has been a request to write data to the data address belonging to the block A associated with the memory group 3, first the data is written to the empty data word 1C, and then the storage status thereof is set to “A-01”.

Next, in cases in which there has been a request again to write data to the data address belonging to block A associated with the memory group 3, data is written to the data word 1A written with the oldest data from out of the data words 1 written with data of block A, and the storage status thereof is set to “A-10”.

Next, in cases in which there has been a request to write data to the data address belonging to the block B associated with the memory group 3, data is written to the data word 1 written with the data of a block different to block B, namely, to the data word 1C written with the oldest data from out of the data words 1 written with the data of block A, and the storage status thereof is set to “B-01”.

Next, in cases in which a request to write data is re-performed for a data address belonging to the block B associated with the memory group 3, data is written to the data word 1B written with the oldest data from out of the data words 1 written with the data of block B, and the storage status thereof is set to “B-10”.

A data backup can be performed in this manner by storing both data prior to updating the designated data address and data after updating in the respective memory group 3.

Moreover, due to the data word 1 where data writing is performed for the same memory group 3 transitioning sequentially at each occurrence of a data write request, the number of times of data rewriting can be uniformly distributed across each of the data words 1 of the same memory group 3. This accordingly means that the number of times of rewriting per single data word 1 can be reduced compared to examples in which content of a given data word 1 is rewritten each time a data write request occurs.

For example, consider an example in which a data rewriting is requested 100 times for each the data addresses of the block A and the block B associated with a particular memory group 3. In such cases, the number of times of data rewriting for each of the data words 1 is [200 (number of times data rewriting occurs for the memory group 3)/3 (number of data words 1 configuring the memory group 3)=67 times (rounding off the first decimal place).

In contrast thereto, a maximum of 100 times of rewriting occurs in the data rewriting processing for the memory of Patent Document 1. This means that, in comparison to a hitherto employed data rewriting method accompanying data backup, the number of times of data rewriting per single data word 1 is reduced by 33%.

Note that although the memory group 3 configured using three data words 1 is employed in the example of the present exemplary embodiment, plural spare data words 1 like the data word 1C may, for example, be prepared in a single memory group 3, or three or more data words 1, like the data word 1A and the data word 1B, may be prepared that are respectively stored with one each of data associated with respective data addresses belonging to a block group that has been split into groups. The number of times of data rewriting in each of the data words 1 in the memory group 3 is reduced by increasing the data words 1 included in the memory group 3. This means that the number of data words 1 contained in the memory group 3 may be set such that the number of times of data rewriting in the respective data words 1 contained in the memory group 3 does not exceed a pre-set maximum number of times.

Although the exemplary embodiment has been employed to describe one form of data rewriting processing of the non-volatile memory 13 of the computer 10, the form of data rewriting processing disclosed is merely an example thereof, and does not limit a scope of the present disclosure. Various modifications and improvements may be implemented to the exemplary embodiment within a scope not departing from a scope of the present disclosure, and embodiments implemented with such various modifications and improvements are contained within the scope of technology disclosed herein.

Description has been given in the exemplary embodiment described above of an example in which the data rewriting processing is implemented by software. However, processing equivalent to that of the flowchart of data rewriting processing illustrated in FIG. 5 may be implemented by hardware processing. In such cases an increase of processing speed is achieved compared to cases in which the data rewriting processing is implemented by software.

Reference to processor in the exemplary embodiment described above indicates a wide definition of processor, and includes general purpose processors (for example the CPU 11), and dedicated processors (for example a graphics processing unit (GPU), an application specific integrated circuit (ASIC), a field programmable gate array (FPGA), a programmable logic device, and the like).

Moreover, operations of the processor of the exemplary embodiment described above are not limited to being performed by a single processor, and may be performed by cooperation between plural processors present at physically distinct locations.

In the exemplary embodiment described above an example has been described in which a program is stored on the non-volatile memory 13. However, the storage destination of the program is not limited to being the non-volatile memory 13. The program of the present disclosure may be provided in a format recorded on a computer-readable storage medium.

For example, the program may be provided in a format recorded on an optical disc such as a compact disk read only memory (CD-ROM), a digital versatile disk read only memory (DVD-ROM), or Blu-ray disk. Moreover, the program may be provided in a format recorded on a portable semiconductor memory, such as a universal serial bus (USB) memory or a memory card. The non-volatile memory 13, CD-ROM, DVD-ROM, Blu-ray disk, USB memory, or memory card are examples of a non-transitory storage medium.

Furthermore, the computer 10 may download the program from an external device in communication with the communication unit 16 by connection through a communication line, and the downloaded program may be stored on the non-volatile memory 13. In such cases, the CPU 11 executes data rewriting processing by reading from the non-volatile memory 13 the program that has been downloaded from the external device, and executes the data rewriting processing.

Supplements according to the present exemplary embodiment are illustrated below.

### Supplement 1

A data rewriting method of processing executed by a computer. The processing includes:
for a memory space including data words for storing data associated with a block number for identifying plural blocks and a data address respectively represented by an address set uniquely for each of the blocks;
in a memory configuration provided with a memory group configured including, in cases in which the plural blocks have been split into two or more block groups, plural data words each respectively stored with data associated with the data address belonging to each of the respective block groups, and including at least one spare data word; and,
in cases in which data of the data address is designated to be updated, from out of the memory group containing data words for storing data of the designated data address, writing data after updating of the designated data address to a data word stored with data prior to updating the data address to be updated, and to a data word other than a data word stored with latest data of the data address belonging to the block group different to a data word for storing data of the data address to be updated.

### Supplement 2

The data rewriting method of processing executed by a computer of supplement 1, wherein:
each data word contained in the memory group includes:
   a block area indicating the block group that the data address associated with stored data belongs to, and
   a sequence area indicating an update sequence of data indicated by the data address; and
the processing further includes selecting a data word for writing with data after updating to the designated data address by referencing the block area and the sequence area.

### Supplement 3

The data rewriting method of supplement 1 or supplement 2, wherein a number of data words contained in the memory group is set such that a number of times of data rewriting to each data word contained in the memory group does not exceed a predetermined number of times.

What is claimed is:

1. A data rewriting method of processing executed by a computer, the processing comprising:
for a memory space including data words for storing data associated with a block number for identifying a plurality of blocks and a data address respectively represented by an address set uniquely for each of the blocks;
in a memory configuration provided with a memory group configured including, in cases in which the plurality of blocks have been split into two or more block groups, a plurality of data words each respectively stored with data associated with the data address belonging to each of the respective block groups and including at least one spare data word; and,
in cases in which data of the data address is designated to be updated, from out of the memory group containing data words for storing data of the designated data address, writing data after updating of the designated data address to a data word stored with data prior to updating the data address to be updated, and to a data word other than a data word stored with latest data of the data address belonging to the block group different to a data word for storing data of the data address to be updated.

2. The data rewriting method of claim 1, wherein:
each data word contained in the memory group includes:
a block area indicating the block group that the data address associated with stored data belongs to, and
a sequence area indicating an update sequence of data indicated by the data address; and
wherein the processing further comprises selecting a data word for writing with data after updating to the designated data address by referencing the block area and the sequence area.

3. The data rewriting method of claim 1, wherein a number of data words contained in the memory group is set such that a number of times of data rewriting to each data word contained in the memory group does not exceed a predetermined number of times.

4. A data rewriting method of claim 2. wherein a number of data words contained in the memory group is set such that a number of times of data rewriting to each data word contained in the memory group does not exceed a predetermined number of times.
